(19) United States
(12) Patent Application Publication
(10) Pub. No.: US 2002/0044900 A1
(43) Pub. Date: Apr. 18, 2002

(54) Harmful gas purifying column and method

(75) Inventors: Kenji Otsuka, Kanagawa (JP); Takashi Shimada, Kanagawa (JP); Tomohisa Ikeda, Kanagawa (JP); Norihiro Suzuki, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Japan Pionics Co., Ltd, Minato-ku (JP)

(21) Appl. No.: 09/929,090

(22) Filed: Aug. 15, 2001

(30) Foreign Application Priority Data
Aug. 30, 2000 (JP) 2000-260094

(51) Int. Cl. B01D 47/00; B01D 45/02; B01D 53/34; B01D 53/46

(52) U.S. Cl. 423/210; 422/171; 422/169; 422/177; 423/237; 423/240 R; 423/215.5; 423/245.1

(57) ABSTRACT

A column for purifying gases by a dry method contains a horizontal plate fitted at a position above a bed of a purifying agent and below a gas inlet, and an upstanding pipe passing through the center of the horizontal plate for guiding harmful gases from the gas inlet to below the horizontal plate, and inner wall surface of the column, upper surface of the horizontal plate and outer wall surface of the pipe form a space defining a collector for the powdered material. Thus there is provided a purifying means which facilitates the purification of harmful gases discharged from e.g. a semiconductor manufacturing process and containing powdered material without accompanying blocking of a purification apparatus, and, thereby, make the operation for the purification and maintenance of the facilities easy, while allowing a purifying agent to exhibit its purifying ability thoroughly.

### BACKGROUND OF THE INVENTION

1. Field of the Invention

This invention relates to a column and a method for purifying harmful gases containing powdered material. More particularly, it relates to a purifying column and a method which facilitate the purification of harmful gases containing powdered material discharged from e.g. a semiconductor manufacturing process without causing any sharp rise in pressure loss, while the purifying operation and maintenance of facilities are easy.

2. Description of the Prior Art

The semiconductor industry uses various kinds of gases, for example, large quantities of hydride gases, such as arsine, phosphine, silanes, diborane, hydrogen selenide. Since these gases are toxic, exhaust gases containing such gases from e.g. a semiconductor manufacturing process require purification before being released into the air. Exhaust gases containing phophine from a semiconductor manufacturing process contain a large quantity of solid particles of phosphorus as a decomposition product, while exhaust gases containing silanes likewise contain solid particles of silicon dioxide, therefore, the disposal of those exhaust gases makes it necessary to consider the removal of solid particles of phosphorus or silicon dioxide.

There is known a dry method of purifying exhaust gases containing phosphine in which the gases are brought into contact with a purifying agent consisting mainly of manganese dioxide and copper oxide, a purifying agent consisting mainly of manganese dioxide and a silver compound, a purifying agent prepared by adding a metal oxide, such as iron oxide or cobalt oxide, to copper oxide and the like, to be purified through a chemical reaction of phosphine with such purifying agent.

There is known a wet method of purifying exhaust gases containing silanes in which a scrubber or spray tower is, for example, used for hydrolyzing the silane gases. There is also known a combustion method in which silane gases are burned in a flame of fuel such as propane. There is also known a dry method in which silanes are brought into contact with a purifying agent consisting mainly of manganese dioxide and copper oxide, a purifying agent consisting mainly of manganese dioxide and a silver compound, or a purifying agent consisting mainly of strontium hydroxide and triiron tetroxide to be purified through a chemical reaction thereof.

### SUMMARY OF THE INVENTION

The known wet method is, however, defective, since blocking of the piping or purifying apparatus caused by silicon dioxide, and the formation of a large amount of slurry complicate the maintenance of the facilities. The combustion method is also defective, since powdered silicon dioxide, which are likely to block a combustion nozzle, have to be removed by e.g. a filter beforehand. In other words, removing the powdered material by a filter usually necessitates an additional system for removing powderly matter besides the purifying apparatus, and in such system, filter is likely to be blocked in a short while, and a frequent change of filters is necessitated.

The dry method is also defective, since a sharp rise in pressure loss is likely to result from the blocking of a bed of a purifying agent with phosphorus or silicon dioxide powder and make it necessary to change the purifying agent to a new one even if it may still have a purifying power.

It is, therefore, an object of this invention to provide an purifying means which facilitate the purification including removal of the powdered material in the harmful gases containing powdered material discharged from e.g. a semiconductor manufacturing process without accompanying the blocking of the purification apparatus and the like, and, thereby, make the operation for the purification and maintenance of the facilities easy, while allowing a purifying agent to exhibit its purifying ability thoroughly.

As a result of our efforts in intensive search for any possible solution to the problems as pointed out above, we, the inventors of this invention, have found as a basis for our invention that if a purifying column intended for carrying out a dry method has a collector for powdered material above a bed of a purifying agent, it is easy to remove any powdered material from harmful gases and purify them without causing any blocking of the bed by the powdered material, thereby any sharp rise in pressure loss, while any after-treatment and the maintenance of the facilities are easy if any powdered material collected in the collector is removed therefrom.

According to one aspect of this invention, therefore, there is provided a column for purifying harmful gases containing powdered material, having a gas inlet, a bed of a purifying agent and a gas outlet for letting out purified gases, wherein the column has a horizontal plate fitted at a position above the bed of a purifying agent and below the gas inlet in the column, so as to allow an outer edge of the horizontal plate to make intimate contact with the inner wall surface of the column; an upstanding pipe passing through the center of the horizontal plate for guiding harmful gases from the gas inlet to below the horizontal plate; and a collector for the powdered material defined by an annular space formed with inner wall surface of the column, upper surface of the horizontal plate and outer wall surface of the pipe.

According to a modified aspect of this invention, there is provided a column for purifying harmful gases containing powdered material, having a gas inlet, a bed of a purifying agent and a gas outlet for letting out purified gases, wherein the column has a horizontal plate fitted at a position above the bed of a purifying agent and below the gas inlet in the column so as to allow an outer edge of the horizontal plate to make intimate contact with the inner wall surface of the column; a plurality of upstanding pipes each passing through the horizontal plate for guiding harmful gases from the gas inlet to below the horizontal plate; and a collector for the powdered material defined by a space formed with inner wall surface of the column, upper surface of the horizontal plate and outer wall surfaces of the pipes.

According to another aspect of this invention, there is provided a method of purifying harmful gases containing powdered material in a column having a gas inlet, a bed of a purifying agent and a gas outlet for letting out purified gases, wherein the harmful gases are guided into a collector for powdered material defined by an annular space formed with the inner wall surface of the column, upper surface of a horizontal plate fitted at a position above the bed of purifying agent and below the gas inlet in the column and having an outer edge making intimate contact with inner wall surface of the column, and outer wall surface of an upstanding pipe passing through the center of the horizontal plate for guiding harmful gases from the gas inlet to below the horizontal plate, so that a part of the powdered material contained in harmful gases falls into the collector, thereafter the gases are brought into contact with the purifying agent to be purified.

According to a modified aspect of this invention, there is provided a method of purifying harmful gases containing powdered material in a column having a gas inlet, a bed of a purifying agent and a gas outlet for letting out purified gases, wherein the harmful gases are guided into a collector for powdered material defined by a space formed with the inner wall surface of the column, upper surface of a horizontal plate fitted at a position above the bed of purifying agent and below the gas inlet in the column and having an outer edge making intimate contact with inner wall surface of the column, and outer wall surface of a plurality of upstanding pipes each passing through the horizontal plate for guiding harmful gases from the gas inlet to below the horizontal plate, so that a part of the powdered material contained in harmful gases falls into the collector, thereafter the gases are brought into contact with the purifying agent to be purified.

### BRIEF DESCRIPTION OF THE DRAWING

FIG. 1 is a schematic vertical sectional view of an example of a purifying column embodying this invention.

### DETAILED DESCRIPTION OF THE INVENTION

This invention is applicable to a column for purifying harmful gases containing powdered material discharged from e.g. a semiconductor manufacturing process and a method of purifying such gases.

The harmful gas purifying column of this invention is characterized by having a horizontal plate fitted at a position above the bed of a purifying agent and below the gas inlet in the column so as to allow an outer edge of the horizontal plate to make intimate contact with the inner wall surface of the column; an upstanding pipe(s) passing through the horizontal plate for guiding harmful gases from the gas inlet to below the horizontal plate; and a collector for the powdered material defined by a space formed with inner wall surface of the column, upper surface of the horizontal plate and outer wall surface of the pipe.

The gas purifying method of this invention is characterized by employing a column as set forth above and guiding gases containing powdered material from a gas inlet into a collector for the powdered material defined in the column by a space formed by inner wall surface of the column, upper surface of the horizontal plate and outer wall surface of the upstanding pipe(s), so that a part of the powdered material contained in harmful gases falls into the collector, thereafter the gasses are brought into contact with the purifying agent to be purified.

The column and method of this invention can be employed for purifying any kind of harmful gases containing powdered material. Examples of such gasses are harmful gasses each containing phosphine and solid particles of phosphorus; silanes, such as silane, disilane, dichlorosilane, trichlorosilane, and solid particles of silicon dioxide; arsine and solid particles of arsenic; or ammonia and solid particles of ammonium chloride, in the base gass, such as nitrogen, hydrogen, argon ,helium.

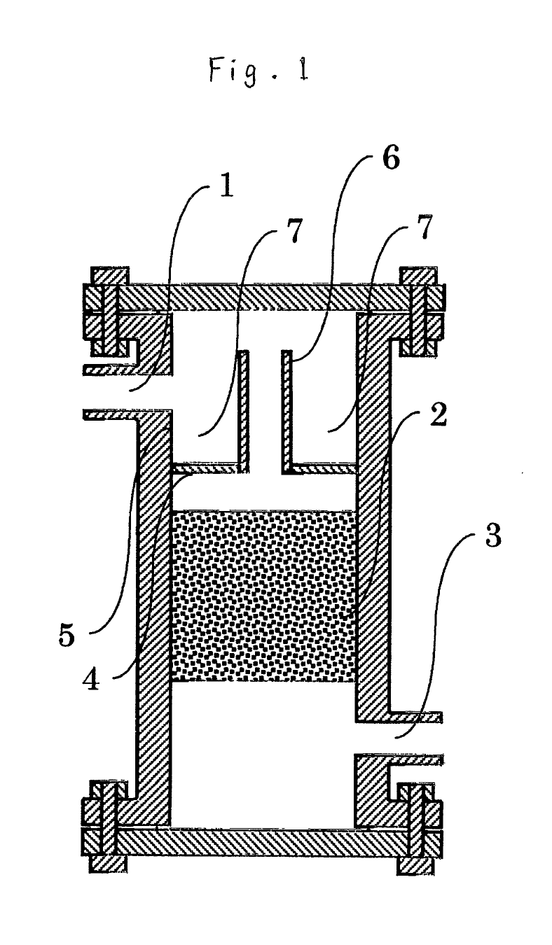

The gas purifying column and method of this invention will now be described in further detail with reference to FIG. 1, though the following description is not intended for limiting the scope of this invention.

FIG. 1 is a schematic sectional view of an example of a purifying column embodying this invention. The column of this invention has a gas inlet 1 of the harmful gas, a bed of a purifying agent 2 and a gas outlet 3 for letting out purified gases. According to a salient feature of this invention, a horizontal plate 4 is fitted at a position above the bed of a purifying agent 2 and below the gas inlet 1 in the column so as to allow an outer edge of the horizontal plate 4 to make intimate contact with the inner wall surface 5 of the column, and upstanding pipe(s) 6 for guiding gases from the gas inlet 1 to below the horizontal plate 4 is fitted passing through the horizontal plate 4. In this invention, a collector 7 for powdered material is formed with an inner wall surface 5 of the column, an upper surface of the horizontal plate 4 and an outer wall surface of the pipe 6. The column of this invention has usually cylindrical form and the horizontal plate 4 is usually a circular disk.

Although the column shown in FIG. 1 has only a single pipe as the upstanding pipe 6 and a modified form of column embodying this invention may have a plurality of pipes. When the column has a single pipe, it is fitted passing through the center of the horizontal plate 4, therefore, the collector 7 for powdered material formed with inner wall surface of the column, upper surface of the horizontal plate and outer wall surface of the pipe has annular space. When the column has a plurality of pipes, they are, for example, fitted so as to place a center of horizontal cross section of each pipe on a circle concentric to and smaller than the horizontal plate, and equally apart from one another. The pipe or pipes are not particularly limited in inside diameter or length, though in the case of the single pipe, it may preferably have an inside diameter which is equal to about 1/20 to ½ of that of the column, while a plurality of pipes may preferably have a total cross-sectional area which is equal to about 1/400 to ¼ of the cross-sectional area of the column, and the (or each) pipe may preferably have a top opening located at a higher level than the gas inlet.

In this invention, the horizontal plate is employed so that its upper surface defines a space forming the collector for powdered material with the inner wall surface of the column and the outer wall surface of the pipe. Therefore, it may have a somewhat uneven surface, or a thickness lacking uniformity, and does not necessarily need to be exactly horizontal. Its outer edge makes intimate contact with the inner wall surface of the column so that no powdered material falls past its outer edge.

The horizontal plate and pipe may be of any material that is resistant to corrosion by harmful gases, and not intended for limiting the scope of this invention. Examples are carbon steel, manganese steel, chromium steel, molybdenum steel, stainless steel, and the like.

The horizontal plate is located above the bed of the purifying agent and below the gas inlet. The upper surface of the horizontal plate and the lower extremity of the gas inlet may have therebetween a distance which depends on the kind of the powdered material and the flow rate of the gases, but which is usually 0.02 to 1.5 times, or preferably 0.1 to 0.5 times as large as the inside diameter of the column. If the distance is less than 0.02 times as large, it may fail to capture the powdered material satisfactorily. If it is over 1.5 times as large, it may not form any more effective collector space, but may undesirably enlarge the column.

The distance between a lower surface of the horizontal plate and a upper extremity of the purifying agent bed is in the range of 1 to 20 cm depending on the inside diameter of the column. It may usually be from 1 to 10 cm for a column having an inside diameter below 20 cm, from 2 to 15 cm for a column having an inside diameter of 20 to 60 cm, or from 3 to 20 cm for a column having an inside diameter above 60 cm. The distance means the height of a usually vacant space between the horizontal plate and the bed of the purifying agent. If the distance is shorter than the lower limit of each range stated above, the harmful gases from the lower end of the pipe contact the purifying agent immediately, in result, the gases flow in an undesirable way lacking uniformity through the bed of the purifying agent, and if it is longer than the upper limit, it may undesirably enlarge the column. It will be effective to place between the horizontal plate and the bed of the purifying agent a baffle having holes for regulating the flow of gases to ensure its uniformity.

Description will now be made of a gas purifying method embodying this invention. It is characterized by employing a column as described above and guiding harmful gases containing powdered material into the column, particularly, into the collector for the powdered material formed with the inner wall surface of the column, the upper surface of the horizontal plate and the outer wall surface of the pipe, so that a part of the powdered material contained in harmful gas falls into the collector thereafter the gases are brought into contact with the purifying agent to be purified.

Referring to FIG. 1, harmful gases containing powdered material discharged from e.g. a semiconductor manufacturing process are introduced into the purifying column through its gas inlet 1 and flow through the collector 7 for powdered material, thereafter, the pipe 6 and the bed of the purifying agent 2, and the purified gases are discharged through the gas outlet 3. The powdered material is partly removed from the harmful gases flowing through the collector by dropping into the collector. The proportion of the powdered material which can be removed is usually 80% or more, though it may depend on the kinds of the harmful gases and powdered material, the flow rate of the gases and the type of the column. It, therefore, follows that the pressure loss of the gases flowing through the bed of the purifying agent increases only at a rate which is equal to, or even lower than ⅕ of the rate which would prevail if there were no collector for powdered material.

Although this invention does not have any specifically limited rate for the gases containing powdered material flowing through the purifying column, it is usually, say, 0.01 to 10 cm/sec. in terms of their linear velocity through an empty column. There is no specifically limited temperature or pressure, either, but a temperature of −20 to 100° C. and atmospheric pressure are usually employed.

The harmful gas purifying column and method of this invention facilitate the purification of harmful gases discharged from e.g. a semiconductor manufacturing process and containing powdered material without causing a sharp rise in pressure loss resulted from blocking of the powdered material. This invention also facilitates any after-treatment and the maintenance of the facilities.

The invention will now be described more specifically by examples, though these examples are not intended for limiting the scope of this invention.

### EXAMPLE 1

Preparation of a Purifying Column:

A column as shown in FIG. 1 was prepared for purifying harmful gases. The column had an inside diameter of 110 mm and a height of 1,000 mm, its gas inlet had an inside diameter of 25 mm, its horizontal plate had an outside diameter of 110 mm and a thickness of 5 mm and its upstanding pipe had an inside diameter of 25 mm and a height of 150 mm. They were all of stainless steel SUS316L. The lower extremity of gas inlet and the upper surface of horizontal plate had a distance of 100 mm therebetween, and the lower surface of horizontal plate and the upper extremity of bed of the purifying agent had a distance of 55 mm therebetween.

Determination of Pressure Loss of Gases in Bed of the Purifying Agent:

A purifying agent was prepared by supporting 30 parts by weight of potassium hydroxide on 100 parts by weight of a commercially available product consisting mainly of manganese dioxide and copper oxide and known as Hopkalite (an extruded product of Nissan Gardler Catalyst Co., Ltd. having a pellet diameter of 1.5 mm and a pellet length of 3 to 10 mm). It was placed in the column to make a bed of the purifying agent having a height of 500 mm.

Harmful gases containing 1.0 mg of SiO₂ per liter and 1,600 ppm of SiH₄ in dry nitrogen were introduced into the column through its gas inlet at a rate giving a linear velocity through an empty column of 2.0 cm/sec. in the bed of the purifying agent, and a difference in pressure was examined every hour between upstream and downstream of the bed. The results are shown in Table 1 below. No SiH₄ was detected from the gas leaving the bed of the purifying agent during the pressure loss determination.

### EXAMPLES 2 to 4

Tests for pressure loss determination were conducted by changing the amount of SiO₂ to 2.0 mg, 3.0 mg and 4.0 mg, respectively, per liter and otherwise repeating Example 1. The results are shown in Table 1. No SiH₄ was detected from the gas leaving the bed of the purifying agent during any of the tests.

### EXAMPLE 5

Preparation of a Purifying Column:

A purifying column was prepared by changing the distance between the lower extremity of gas inlet and the upper surface of horizontal plate to 50 mm and otherwise repeating Example 1.

Determination of Pressure Loss in Bed of the Purifying Agent:

A test for pressure loss determination was conducted by employing a new column as described and otherwise repeating Example 1. The results are shown in Table 1. No SiH₄ was detected from the gas leaving the bed of the purifying agent during the test.

### EXAMPLES 6 to 8

Tests for pressure loss determination were conducted by employing the purifying column of Example 5, changing the amount of SiO₂ to 2.0 mg, 3.0 mg and 4.0 mg, respectively, per liter and otherwise repeating Example 1. The results are shown in Table 1. No SiH₄ was detected from the gas leaving the bed of the purifying agent during any of the tests.

### COMPARATIVE EXAMPLE 1

Preparation of a Purifying Column:

A purifying column was prepared by removing the horizontal plate and the upstanding pipe from the purifying column shown in FIG. 1 and repeating Example 1 in respect of the inside diameter and height of the column and the position of the bed of the purifying agent.

Determination of Pressure Loss in Bed of the Purifying Agent:

A test for pressure loss determination was conducted by employing the column as described and otherwise repeating Example 1. The results are shown in Table 1. No SiH₄ was detected from the gas leaving the bed of the purifying agent during the test.

### COMPARATIVE EXAMPLES 2 to 4

Tests for pressure loss determination were conducted by employing the purifying column of Comparative Example 1, changing the amount of SiO₂ to 2.0 mg, 3.0 mg and 4.0 mg, respectively, per liter and otherwise repeating Example 1. The results are shown in Table 1. No SiH₄ was detected from the gas leaving the bed of the purifying agent during any of the tests.

TABLE 1

| | | | Pressure | | |
|---|---|---|---|---|---|
| | Distance between gas inlet | SiO₂ | difference (Pa) | | |
| | and horizontal plate/I.D. of | content | After | After | After |
| | column | (mg/l) | 2 hr | 4 hr | 6 hr |
| Example 1 | 100/110 | 1.0 | 0 | 0 | 0 |
| Example 2 | 100/110 | 2.0 | 0 | 0 | 0 |
| Example 3 | 100/110 | 3.0 | 0 | 0 | 0 |
| Example 4 | 100/110 | 4.0 | 0 | 0 | 0 |
| Example 5 | 50/110 | 1.0 | 0 | 0 | 0 |
| Example 6 | 50/110 | 2.0 | 0 | 0 | 0 |
| Example 7 | 50/110 | 3.0 | 0 | 0 | 0 |
| Example 8 | 50/110 | 4.0 | 0 | 0 | 0 |
| Comparative | — | 1.0 | 0 | 20 | 40 |
| Example 1 | | | | | |
| Comparative | — | 2.0 | 30 | 190 | 660 |
| Example 2 | | | | | |
| Comparative | — | 3.0 | 40 | 660 | 1800 |
| Example 3 | | | | | |
| Comparative | — | 4.0 | 190 | 1300 | 3400 |
| Example 4 | | | | | |

What is claimed is:

1. A column for purifying harmful gases containing powdered material, having a gas inlet, a bed of a purifying agent and a gas outlet for letting out purified gases, wherein the column has a horizontal plate fitted at a position above the bed of a purifying agent and below the gas inlet in the column so as to allow an outer edge of the horizontal plate to make intimate contact with the inner wall surface of the column; an upstanding pipe passing through the center of the horizontal plate for guiding harmful gases from the gas inlet to below the horizontal plate; and a collector for the powdered material defined by an annular space formed with inner wall surface of the column, upper surface of the horizontal plate and outer wall surface of the pipe.

2. A column for purifying harmful gases containing powdered material, having a gas inlet, a bed of a purifying agent and a gas outlet for letting out purified gases, wherein the column has a horizontal plate fitted at a position above the bed of a purifying agent and below the gas inlet in the column so as to allow an outer edge of the horizontal plate to make intimate contact with the inner wall surface of the column; a plurality of upstanding pipes each passing through the horizontal plate for guiding harmful gases from the gas inlet to below the horizontal plate; and a collector for the powdered material defined a space formed with inner wall surface of the column, upper surface of the horizontal plate and outer wall surfaces of the pipes.

3. The column according to claim 1 or 2, which has an empty space between the horizontal plate and the bed of the purifying agent.

4. The column according to claim 1 or 2, further include a baffle located between the horizontal plate and the bed of a purifying agent and having holes for regulating the flow of the harmful gases.

5. The column according to claim 1 or 2, wherein the pipe has a top opening located at a higher level than the gas inlet.

6. The column according to claim 1 or 2, wherein lower extremity of the gas inlet and upper surface of the horizontal plate have therebetween a distance which is 0.02 to 1.5 times as large as the inside diameter of the column.

7. The column according to claim 1 or 2, wherein lower surface of the horizontal plate and upper extremity of the bed of purifying agent have a distance of 1 to 20 cm therebetween.

8. A method of purifying harmful gases containing powdered material in a column having a gas inlet, a bed of a purifying agent and a gas outlet for letting out purified gases, wherein the harmful gases are guided into a collector for powdered material defined by an annular space formed with inner wall surface of the column, upper surface of a horizontal plate fitted at a position above the bed of purifying agent and below the gas inlet in the column and having an outer edge making intimate contact with inner wall surface of the column, and outer wall surface of an upstanding pipe passing through the center of the horizontal plate for guiding harmful gases from the gas inlet to below the horizontal plate, so that a part of the powdered material contained in harmful gases falls into the collector, thereafter the gases are brought into contact with the purifying agent to be purified.

9. A method of purifying harmful gases containing powdered material in a column having a gas inlet, a bed of a purifying agent and a gas outlet for letting out purified gases, wherein the harmful gases are guided into a collector for powdered material defined by a space formed with inner wall surface of the column, upper surface of a horizontal plate fitted at a position above the bed of purifying agent and below the gas inlet in the column and having an outer edge making intimate contact with inner wall surface of the column, and outer wall surface of a plurality of upstanding pipes each passing through the horizontal plate for guiding harmful gases from the gas inlet to below the horizontal plate, so that a part of the powdered material contained in harmful gases falls into the collector, thereafter the gases are brought into contact with the purifying agent to be purified.
